(19) United States
(12) Patent Application Publication
(10) Pub. No.: US 2016/0045891 A1
(43) Pub. Date: Feb. 18, 2016

(54) LIQUID-RETAINING MIXTURE AND MANUFACTURING METHOD FOR LIQUID-RETAINING CARRIERS

(71) Applicant: HONG KONG ERT LIMITED, Hong Kong (HK)

(72) Inventors: CHIA-CHIH HAN, NEW TAIPEI CITY (TW); HUAN-CHUNG HSU, NEW TAIPEI CITY (TW)

(21) Appl. No.: 14/616,788

(22) Filed: Feb. 9, 2015

Related U.S. Application Data
(63) Continuation-in-part of application No. 14/460,754, filed on Aug. 15, 2014.

(51) Int. Cl. B01J 20/16; B01J 20/02; B01J 20/30; B01J 20/04

(52) U.S. Cl. CPC B01J 20/16; B01J 20/045; B01J 20/02; B01J 20/3078; B01J 20/3021

(57) ABSTRACT

The present invention discloses a liquid-retaining mixture which comprises a liquid solution, a solid industrial waste, an aluminum oxide compound, and a silicon dioxide compound. A liquid-retaining carrier derived from the waste mixture can be used for retaining liquid substances in soil. The present invention also discloses a manufacturing method for a liquid-retaining carrier.

### CROSS REFERENCE TO RELATED APPLICATION

This Application is a Continuation-in-Part of application Ser. No. 14/460,754 filed on 15 Aug. 2014 and entitled “ CERAMIC TILE PRODUCTS AND MANUFACTURING METHOD THEREOF” , now pending, the entire contents of which are hereby incorporated by reference.

### BACKGROUND OF THE INVENTION

1. Field of the Invention

The instant disclosure relates to a substrate for soil improvement that has a water-storing property; in particular, to a liquid-retaining mixture that utilizes solid waste generated from industrial emissions as a raw material, and to a manufacturing method for a liquid-retaining carrier derived from the liquid-retaining mixture.

2. Description of Related Art

Phosphogypsum (CaSO₄.2H₂O) is a solid industrial waste generated from wet phosphoric acid production process, and making 1 ton of phosphoric acid produces 4.5-5 tons of phosphogypsum. With the rapid development of phosphate fertilizer and efficient phosphate industry, the emission of phosphogypsum waste is increasing. In the world, annual phosphogypsum emission amount is about 280 million tons. If there is not a reasonable treatment and utilization, the abundant stockpile of phosphogypsum will restrict the development of the industry as a whole because of the existence of phosphorus pentoxide, fluorine and free acid and other harmful substances in phosphogypsum. Currently, the accumulated stockpile of phosphogypsum in China is more than 250 million tons. However, the effective utilization ratio is less than 20%, even though worldwide average utilization ratio of phosphogypsum is only 4.5%, generally used for low-level applications such as building materials, cement, soil improvement, or directly as a roadbed.

It is a known fact that phosphogypsum (CaSO₄.2H₂O) is quite soluble in fresh water (about 2 grams per 1000 cc). That solubility raises some concerns when phosphogypsum is used as fill material to raise levees retaining water, or if it is used as construction material in a road base on a pervious foundation because the protective asphaltic or concrete surface course is susceptible to shrinkage cracking over time. The solubility of phosphogypsum results in a loss of material over time, potential piping associated with preferential flow paths, and potential increased sulfate and calcium concentrations in the receiving waters, particularly groundwater, unless the surface course is regularly maintained and frequently resurfaced. Therefore, a need exists to develop alternative methods to promote beneficial use of the phosphogypsum.

A variety of products are marketed to improve water retention of soils. They include gels, beads or other compounds based on petroleum or oil derivatives. These products are not only based on non-renewable and non-biodegradable resources but also require special handling and application procedures since they contain chemical agents that can be hazardous if long term exposure or mishandling occurs during its storage or application. Most of these products are not suitable for large farms or forest areas due to their high cost. Even if their cost is reduced through more efficient processes or subsidies, many of the existing products contain chemical agents that make them non-suitable or not recommended for use in some crops. Existing products in this category use expensive, non-renewable raw materials such as petroleum, or chemical compounds that make them hazardous for use in farming land or for human consumption crops.

There exist also organic materials that are used to aid in water retention on soils. Prominent in this category are compost, mulch and other mineral-based products.

Compost is obtained from the decomposition process of organic waste assisted by waste-digesting worms that accelerate the process of decomposition. Worms accelerate this process creating an organic mass that has some water retention capabilities. In some regions in the southwest United States, compost is used as an aid in the maintenance of golf courses. However, the production cycle for compost is extremely long, the production of a metric ton of compost requires months of decomposition of organic material and it is a process that cannot be industrialized easily. This makes the cost of the compost increase and the production volumes shrink. Even though compost is an organic and renewable alternative, the limitations in production capacity and the elevated cost related to its production hamper its viability as an option to reduce water consumption for large arid regions that have a strong population growth and a growing demand for water.

Mulch is usually obtained from bark, compost, grass clippings or straw and is spread or laid over the surface of the soil as a covering. It is used to retain moisture in the soil and suppress weeds. It also keeps the soil cool and makes the garden bed look more attractive. Organic mulches also help improve the soil's fertility, as they decompose. Compost and mulch have a low percentage of water retention for their weight or volume. Both materials also lose accumulated moisture at a high rate.

Finding a replacement for the natural mineral resources as raw materials will help immensely in an effort to protect the environment and dramatically reduce the production cost of ceramic tile products. All around the world, many companies within the industry face the imminent problem of waste pile up and pollution. If wastes can be used as raw materials for ceramic tile products, not only will the production costs of the ceramic tiles products, but also the detrimental effects of the wastes on the environment, be significantly reduced.

To address the above issues, the inventor strives via associated experience and research to present the instant disclosure, which can effectively improve the limitation described above.

### SUMMARY OF THE INVENTION

The objective of the instant disclosure is to provide a liquid-retaining mixture and a manufacturing method for a liquid-retaining carrier which utilizes solid waste and gypsum generated from the production of phosphorous as a raw material to recycle resources as well as protect the environment.

In order to achieve the aforementioned objects, the instant disclosure provides according to an embodiment, a liquid-retaining mixture for retaining liquid substances in soil, comprising: (a) a liquid solution, (b) a solid industrial waste, (c) an aluminum oxide compound, and (d) a silicon dioxide compound, wherein a volume ratio of a liquid-retaining carrier derived from the waste mixture to the soil is better than 10% to 25% of the mixing ratio, but at least on 5%.

The instant disclosure further provides a manufacturing method for a liquid-retaining carrier according to the aforementioned liquid-retaining mixture. The manufacturing method comprises: providing a liquid solution, a solid industrial waste, and aluminum oxide and silicon dioxide compounds; mixing the solid industrial waste and the aluminum oxide, boric acid, and silicon dioxide compounds with the liquid solution to produce a liquid-retaining mixture; heating the liquid-retaining mixture to produce a compound melt, and cooling the glass melt to produce a solid ceramic product; and breaking down the solid ceramic product to produce ceramics composite carrier particles.

In summary, the liquid-retaining carrier for use on soil comprises ceramics composite carrier particles with a high proportion of micro porosity for humidity and rich in organic materials as fertilizer content inside. Accordingly, the liquid-retaining carrier can be used in farming for regular crops, fruit producing trees, grazing and forest land, as well as in parks and recreation areas in cities or towns and in any area where it is necessary to increase the percentage of humidity in the soil and subterranean layers.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 shows a flow diagram of a manufacturing method for liquid-retaining carrier according to a preferred embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

With the purpose for a safe disposal and reducing the volume of solid waste and its treatment costs, the present invention provides a liquid-retaining carrier that utilizes solid waste generated from industrial emissions as a raw material. Especially, the liquid-retaining carrier has a significantly lower desorption rate of liquid substances, i.e., water, culture medium, or other fluids, and thus can be used for soil and fertilizers to improve water retention and workability to promote better plant growth. Accordingly, the present invention not only can solve solid waste problems, but also can convert solid waste into economic and environmental benefits.

The liquid-retaining carrier is derived from a liquid-retaining mixture which comprises a solid industrial waste, a liquid solution, and aluminum oxide and silicon dioxide compounds. Specifically, the liquid-retaining mixture uses the development of the solid industrial waste mixed with other materials that aid in water retention on arid or drought areas to improve the performance of farming, grazing, and forest soils as well as to help reduce water consumption in city parks and recreation areas and domestic green areas.

The liquid-retaining mixture uses the waste phosphogypsum (solid industrial waste) generated from wet phosphoric acid production process or desulfurization process. “Phosphogypsum” is a general industrial solid waste, category II, which is a solid waste discharged during the production of phosphate and phosphoric acid or from the industrial emissions of the desulfurization process. The main composition of phosphogypsum includes calcium, magnesium, and phosphorus pentoxide. The effective content of calcium oxide is up to 36 to 38%, while the effective content of magnesium oxide is up to 8 to 9%, whereas the effective content of phosphorous pentoxide is up to 2 to 3% in phosphogypsum. The waste phosphogypsum, when combined with other materials mentioned in the following paragraphs, forms a new mixture that has the capacity to store moisture for later transfer to the soil where is applied. Accordingly, the use of phosphogypsum for the production of the liquid-retaining carrier not only effectively reduces solid waste pileup, but also further reduces the chance of air, water, and land pollution, as well as protecting the environment.

A representative example of the liquid-retaining carrier can be used to totally replace natural soils for growing plants. The liquid-retaining carrier comprises sintered ceramics composite carrier particles, where the particle size distribution can be controlled according to different growth conditions and/or various kinds of plants. Preferably, the sintered ceramics composite carrier particles have a particle size between 0.5 and 100 mm. The sintered ceramics composite carrier particles contain aluminum oxide and silicon dioxide compounds and has been bonded by vitrified ceramic bonds.

Another representative example of the liquid-retaining carrier is that it can act as a plant growth medium and be used in soil to enhance water-retention properties of the soil to efficiently maintain soil or growth medium in any environmental conditions and to efficiently prevent desertification. The liquid-retaining carrier comprises sintered ceramics composite carrier particles, where the particle size distribution can be controlled under environmental factors such as climate or land use change. Preferably, the sintered ceramics composite carrier particles have a longest dimension greater than or less than 300 mm and a shortest dimension greater than or less than 1 mm. The sintered ceramics composite carrier particles contain aluminum oxide and silicon dioxide compounds and have been bonded by vitrified ceramic bonds.

Moreover, the spacing between the sintered ceramics composite carrier particles can be configured to accommodate liquid substances, and the hydrophilic property of the sintered ceramics composite carrier particles can help produce the water retention effect. Generally, the higher the hydrophilic property, the better water retention effect is produced. Therefore, the liquid-retaining carrier can be used for soil to enhance water-retention properties of liquid substances, i.e., water or the liquid mixture of water and growth-enhancing elements for enhancing plant growth such as nitrogen, phosphate, and potassium, etc.

The liquid solution can be, but is not limited to, a polymer-containing solution, configured to suspend a cluster of the solid industrial waste and the aluminum oxide and silicon dioxide solid compounds. In practice, the aluminum oxide and silicon dioxide compounds can be added simultaneously or respectively into the polymer-containing solution to produce a liquid-retaining mixture after mixing.

Preferably, a thermal catalyst can be further added into the polymer-containing solution. The liquid-retaining mixture in this way further comprises a thermal catalyst. The thermal catalyst and the aluminum oxide and silicon dioxide compounds can be added simultaneously or respectively into the polymer-containing solution. The thermal catalyst can be, but is not limited to, an alkali metal or alkaline-earth metal compound, configured to promote the formation of vitrified ceramic bonds between the compounds such as silicon dioxide (SiO₂) and the aluminum oxide compound. Accordingly, with the energy converted from heating at a constant temperature below 900° C., preferably below 850° C., the crystal lattice of the silicon dioxide compound must be broken down to incorporate with heavy metal and metal ions. For example, a uniformly vitrified ceramic bond can be formed between Al and Si under the deeply sintered condition. Besides, toxic substances (which are the risk to human and environmental health) such as fluorine and phosphate ions from the waste phosphogypsum can also be incorporated into the broken crystal lattice of the silicon dioxide compound to produce a glass melt form in the structure of substances which is held in a stable state. After cooling the glass melt, a solid ceramic product can be formed.

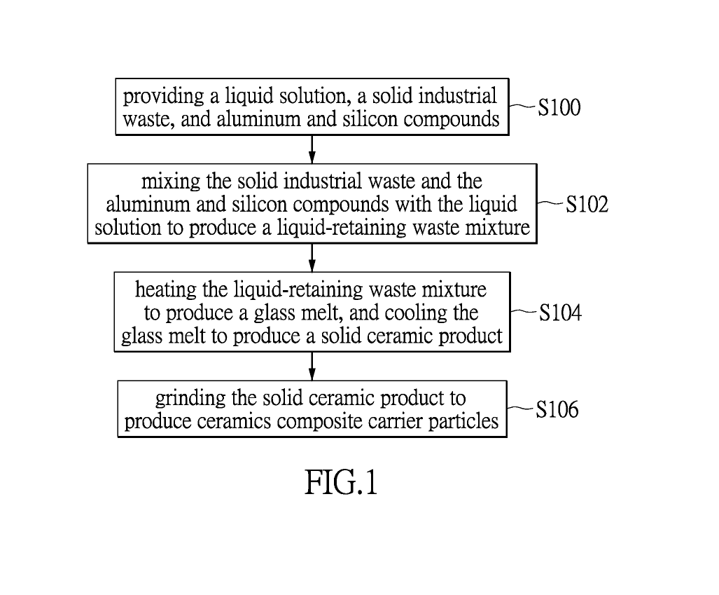

The following further discloses the details of the manufacturing method for liquid-retaining carrier. Please refer to FIG. 1, a manufacturing method for a liquid-retaining carrier in accordance with a preferred embodiment is provided. The method comprises the steps of: providing a liquid solution, a solid industrial waste, and aluminum and silicon compounds (S100); mixing the solid industrial waste and the aluminum and silicon compounds with the liquid solution to produce a liquid-retaining mixture (S102); heating the liquid-retaining mixture to produce a glass melt, and cooling the glass melt to produce a solid ceramic product (S104); and breaking down the solid ceramic product into the form of particles (S106).

In the first step S100, the liquid solution and the aluminum and silicon compounds can be added simultaneously or respectively to the solid industrial waste. For the instant embodiment, the liquid solution is a polymer-containing solution, the aluminum compound is aluminum oxide (Al₂O₃), the silicon compound is silicon dioxide (SiO₂), and the solid industrial waste is phosphogypsum generated from a wet phosphoric acid production process or desulfurization process, where the materials are not restricted thereto.

In the next step S102, the mixing process can be conducted when the liquid solution and some materials containing alumina and silica compounds are continuously or completely added to the solid industrial waste to form a liquid-retaining mixture. Using the materials mentioned in this document, liquid solution, solid industrial waste, and the aluminum and silicon compounds, in the proper quantities allows us to create a new ground material. The ground material can be produced in large quantities, and its mechanical and biological properties improve the levels of humidity in the soil.

In the next step S104, the liquid-retaining mixture can be heated at a temperature of from 1130 to 1200° C. to form the glass melt with vitrified ceramic bonds therein by any suitable heating means. The glass melt is filled in the surface of the inorganic material particles and then cooled to a relatively low temperature to form the solid ceramic product. For the instant embodiment, a thermal catalyst can also be provided and added to the solid industrial waste in steps S100 and S102. Thus, the liquid-retaining mixture can be heated at a temperature of about 900° C., preferably below 850° C., in the present of the thermal catalyst. Please note, means for detecting the presence of vitrified ceramic bonds within the glass melt will not be restricted unnecessarily.

In the last step S106, the solid ceramic product can be broken down into the ground material by the grinding unit. For the instant embodiment, the solid ceramic product is preferably broken down by shredding and/or crushing in a roller-crusher and during this operation, the enhanced difference in fracture toughness or ductility is used to advantage to produce generally uniformly granular particles (ceramic composite carrier particles). The particles can be used or applied directly over the soil as a top layer that is simply used to cover the surface of the soil, also can be used alone and laid on the soil surface to prevent the growth of weeds. The particles can also be mixed with the top layer of soil that is targeted for improvement. Besides, it can be used in pots or in tree ponds above or below the soil.

In summary, the liquid-retaining carrier for use on soil comprises ceramic composite carrier particles with high humidity content and that are rich in organic materials as fertilizer. Accordingly, the liquid-retaining carrier can be used in farming for regular crops, fruit producing trees, grazing and forest land, as well as in parks and recreation areas in cities or towns and in any area where it is necessary to increase the percentage of humidity in the soil and subterranean layers.

The liquid-retaining carrier made from the manufacturing method in accordance with the instant disclosure mainly uses phosphogypsum, a solid waste that is generated during the production of phosphoric acid, to replace the conventional natural minerals such as feldspar or pottery stone. The mining of natural minerals is reduced, the material costs of the tiles are effectively reduced, and the earth's resources and energy are effectively protected. Moreover, the use of gypsum for tile production not only effectively reduces solid waste pileup, but also further reduces the chance of air, water, and land pollution, as well as protecting the environment.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

What is claimed is:

1. A liquid-retaining mixture for retaining liquid substances in soil, comprising: (a) a liquid solution, (b) a solid industrial waste, (c) an aluminum compound, and (d) a silicon compound, wherein a volume ratio of a liquid-retaining carrier derived from the waste mixture to the soil is better than 10% to 25% of the mixing ratio, but at least on 5%.

2. The liquid-retaining mixture according to claim 1, wherein the component (a) is phosphogypsum.

3. The liquid-retaining mixture according to claim 1, further comprising:
(e) a thermal catalyst.

4. The liquid-retaining mixture according to claim 1, wherein the component (e) is an alkali metal or alkaline-earth metal compound.

5. A manufacturing method for liquid-retaining carrier, comprising the steps of:
providing a liquid solution, a solid industrial waste, and aluminum and silicon compounds;
mixing the solid industrial waste and the aluminum and silicon compounds with the liquid solution to produce a liquid-retaining mixture;
heating the liquid-retaining mixture to produce a glass melt, and cooling the glass melt to produce a solid ceramic product; and
breaking down the solid ceramic product to produce ceramics composite carrier particles.

6. The manufacturing method according to claim 5, wherein said step of heating comprises heating the liquid-retaining mixture at a temperature of from 1130 to 1200° C.

7. The manufacturing method according to claim 5, wherein said step of mixing comprises adding a thermal catalyst to the liquid-retaining mixture.

8. The manufacturing method according to claim 7, wherein said step of heating comprises heating the liquid-retaining mixture at a temperature of about 850° C.

9. The manufacturing method according to claim 5, wherein the ceramics composite carrier particles have a particle size between 0.5 and 100 mm, configured for use in soil to grow plants.

10. The manufacturing method according to claim 5, wherein the ceramics composite carrier particles have a particle size between 1 and 300 mm, configured for use in soil to enhance water-retention properties of the soil.
